(19) United States
(12) Patent Application Publication
(10) Pub. No.: US 2025/0092738 A1
(43) Pub. Date: Mar. 20, 2025

(54) LIGHT-BLOCKING FABRIC AND MANUFACTURING METHOD THEREFOR

(71) Applicant: WINPLUS CO., LTD., Cheongju-si Chungcheongbuk-do (KR)

(72) Inventor: Tae Woong BYUN, Daejeon (KR)

(73) Assignee: WINPLUS CO., LTD., Cheongju-si Chungcheongbuk-do (KR)

(21) Appl. No.: 18/965,095

(22) Filed: Dec. 2, 2024

Related U.S. Application Data
(63) Continuation-in-part of application No. 16/765,568, filed on May 20, 2020, now Pat. No. 12,195,888.

(30) Foreign Application Priority Data
Jan. 26, 2018 (KR) 10-2018-0010179

(51) Int. Cl. E06B 9/386; E06B 9/24; E06B 9/262; E06B 9/36

(52) U.S. Cl. CPC E06B 9/386; E06B 9/262; E06B 9/36; E06B 2009/2405; E06B 2009/2458; E06B 2009/2622

(57) ABSTRACT

The present invention relates to: a light-blocking fabric usable in blinds for shading or wind protection. The light-blocking fabric includes two light-shielding parts made of a non-transparent fabric, and a light-transmitting part located between the two light-shielding parts, and attached to each of the two light-shielding parts along a longitudinal direction. The light-transmitting part starts attaching to each of the two light-shielding parts at the position that is at least half of a width of each of the two light-shielding parts away from an inner end of each of the two light-shielding parts in a width direction. The longitudinal direction along which the light-transmitting part is attached to each of the two light-shielding parts is perpendicular to the width direction of the each of the two light-shielding parts.

### CROSS-REFERENCE TO RELATED APPLICATIONS

This application is a continuation-in-part of U.S. patent application Ser. No. 16/765,568 filed on May 20, 2020, which is a national phase of International Application No. PCT/KR2018/013704 filed on Nov. 12, 2018, which claims priority to Korean Patent Application No. 10-2018-0010179 filed on Jan. 26, 2018, the entire contents of which are herein incorporated by reference.

### TECHNICAL FIELD

The present invention relates to a light-blocking fabric usable for blinds for shading or wind protection and a manufacturing method therefore.

### BACKGROUND ART

In general, curtains or blinds are mainly used to be installed in a building and serve as shading or wind protection. Here, curtains are a generic term for curtains installed on windows or doorways of buildings or used as partitions, and blinds refer to objects that contact windows to block light.

Blinds can adjust the degree of shading in a variety of ways. Depending on the shading method and structure, the blinds may be classified into vertical blinds, Venetian blinds, Roman shades, roller blinds, and the like.

Among the above-mentioned types of blinds, vertical blinds are relatively inexpensive, easy to install and use, and can create a unique and elegant appearance, so the vertical blinds are installed and used on window frames of verandas or balconies of a multi-family house such as a tenement house and apartment, or on the inside of windows of an offices or officetel.

While the vertical blinds can control the amount of light entering the room, and can allow a person to see outside views even when the blinds are closed, a person in the room can be seen and observed from outside because the vertical blinds are composed of a plurality of vertical slats, which is disadvantageous in that the vertical blinds may not be suitable for privacy. To prevent this, a method of changing the angle of the blind slats is used, but in this case, the degree of light transmittance of the vertical blinds may be lowered.

Additionally, the vertical blinds are generally made of synthetic resin, wood, aluminum sheets, fiber, or the like, and perform only a shading function. Accordingly, this may be inadequate to provide a decorative effect to interior functions of rooms, thereby making it difficult to gentrify the appearance of products, and the productability may be reduced due to the uniformity of manufacturing costs.

Accordingly, in an effort to overcome the above technical problems, for curtain-type vertical blinds in which a light-transmitting part and a non-light-transmitting part are woven, various attempts have been made to provide a shading function, a privacy protection function, a decorative effect, and an insulating effect.

In the case of conventional art invented by the present inventor, upon winding in a roll form, wrinkles may be generated on a light-transmitting part due to an inner space formed due to the difference in thickness between the light-transmitting part made of a mesh fabric and a light-shielding part made of a non-transparent fabric. Additionally, upon winding in a roll form, wrinkles may be generated on the inside of the light-shielding part due to the difference in circumference between the inside and the outside of the light-shielding part, which may cause a reduction in productability.

Moreover, when a blind is unfolded as needed, the gaps in the blind may be eccentrically widened.

### DISCLOSURE

### Technical Problem

Accordingly, the present invention has been made keeping in mind the above problems occurring in the related art,
and an objective of the present invention is to provide a light-blocking fabric by improving the conventional technology invented by the present inventor, wherein the light-blocking fabric is manufactured by attaching a light-transmitting part made of a mesh fabric between two light-shielding parts made of a non-transparent fabric, whereby when wound in a roll form, the light-blocking fabric is wound uniformly without wrinkles on the inside of the light-shielding parts, which may occur due to the difference in circumference between the inside and the outside of the light-shielding parts.

Another objective of the present invention is to provide a light-blocking fabric, wherein when wound in a roll form, the light-blocking fabric is wound uniformly without wrinkles on a light-transmitting part, which may occur due to an inner space formed due to the difference in thickness between the light-transmitting part made of a mesh fabric and a light-shielding part made of a non-transparent fabric.

Still another objective of the present invention is to provide a light-blocking fabric capable of preventing the problem that when a blind manufactured using the light-blocking fabric is unfolded as need, the gaps in the blind may be eccentrically widened.

### Technical Solution

In order to accomplish the above objective, the present invention provides a light-blocking fabric usable for blinds for shading or wind protection, the light-blocking fabric including: two light-shielding parts made of a non-transparent fabric; and a light-transmitting part located between the two light-shielding parts, and attached to the light-shielding parts to a position that is at least half of any one surface of the light-shielding parts so as to overlap therewith along a longitudinal direction, wherein the light-shieling parts and the light transmitting part may be attached together by various methods such as hot melting, an adhesive, sewing, or ultrasonic welding.

Furthermore, the present invention provides a manufacturing method for a light-blocking fabric, the manufacturing method including: (a) a first injection step of unwinding two light-shielding part fabrics wound in a roll form, and injecting the same into a fabric processing apparatus; (b) a coating step of coating, with an adhesive, the position of at least half of any one surface of the two light-shielding part fabrics in the longitudinal direction while the two light-shielding part fabrics move along a guide part of the fabric processing apparatus; (c) a second injection step of unwinding a mesh fabric wound in a roll form, horizontally arranging and injecting the same into the fabric processing apparatus such that the same overlaps with the two light-shielding part fabrics on which the adhesive is coated in the coating step, at a position therebetween; (d) a manufacturing step of manufacturing a light-blocking fabric by attaching, to the mesh fabric injected in the second injection step, the two light-shielding part fabrics on which the adhesive is coated in the coating step along the guide part of the fabric processing apparatus; and (e) a winding step of winding, in a roll form, the light-blocking fabric manufactured in the manufacturing step.

In addition, according to the invention, a light-blocking fabric unit include two light-shielding parts (110) made of a non-transparent fabric; and a light-transmitting part (120) located between the two light-shielding parts (110), and attached to each of the two light-shielding parts (110) along a longitudinal direction. The light-transmitting part (120) is attached at a position located at least halfway along a width of any one surface of each of the two light-shielding parts along the longitudinal direction.

In addition, according to the invention, the light-transmitting part (120) starts attaching to each of the two light-shielding parts (110) at the position that is at least half of a width of each of the two light-shielding parts (110) away from an inner end of each of the two light-shielding parts (110) in a width direction.

In addition, according to the invention, the longitudinal direction along which the light-transmitting part (120) is attached to each of the two light-shielding parts (110) is perpendicular to the width direction of the each of the two light-shielding parts (110).

In addition, according to the invention, the light-blocking fabric unit of claim 1, wherein the light-transmitting part (120) is attached to light-shielding part (110) in an area, and the area is a partial area of an overlapping part (121) where each of the two light-shielding parts (110) overlaps with the light-transmitting part (120).

In addition, according to the invention, the light-shielding parts (110) and the light-transmitting part (120) are attached together with a hot-melt or adhesive.

In addition, according to the invention, the light-shielding parts (110) and the light-transmitting part (120) are attached together by sewing or ultrasonic welding.

In addition, according to the invention, the light-transmitting part is attached to each of the two light-shielding parts (110) at one or more positions along the longitudinal direction.

In addition, according to the invention, an inner surface of each of both edges of the light-transmitting part (120) in a width direction is attached to corresponding surface of each of the two light-shielding parts (110).

In addition, according to the invention, the light-transmitting part (120) includes an overlapping part (121) that overlaps with each of the two light-shielding parts (110) when the light transmitting part (120) is attached to each of the two light-shielding parts (110). The overlapping part (121) includes an attachment part (122) where the light-transmitting part (120) is attached to each of the two light-shielding parts (110) and a non-attachment part (124) where the light-transmitting part (120) is not attached to any of the two light-shielding parts (110).

In addition, according to the invention, a blind include the light-blocking fabric above is provided.

### Advantageous Effects

According to the present invention, the light-blocking fabric is manufactured by attaching the light-transmitting part along the longitudinal direction to the position of at least half of any one surface of the two light-shielding parts. Thus, when wound in a roll form, the light-blocking fabric can be wound uniformly without wrinkles on the light-shielding parts and the light-transmitting part by balancing the thickness of the light-shielding parts and the light-transmitting part, thereby making it possible to prevent the problem of degrading the aesthetic appearance due to wrinkles. It is also possible to prevent the problem that when a blind manufactured using the light-blocking fabric is folded as need, the gaps in the blind may be eccentrically widened.

### DESCRIPTION OF DRAWINGS

FIG. 1 is a view illustrating a configuration of a light-blocking fabric according to the present invention.

FIG. 2 is a conceptual view illustrating a manufacturing method fora light-blocking fabric according to the present invention.

FIG. 3 is a sectional view illustrating a problem occurring in the conventional art invented by the present inventor.

FIG. 4 is a sectional view illustrating an improved appearance due to the light-blocking fabric according to the present invention.

FIGS. 5 to 8 are plan views illustrating a method of improving the conventional art invented by the present inventor.

FIG. 9 is a conceptual view illustrating an example of a method of coupling a plurality of pieces of the light-blocking fabric according to the present invention.

FIG. 10 is a perspective view illustrating a fixing means in the form of a clip for fixing the light-blocking fabric manufactured by the manufacturing method according to the embodiment.

FIG. 11 is a view illustrating a state in which a blind formed by fixedly coupling a plurality of pieces of the light-blocking fabric manufactured by the manufacturing method according to an embodiment is unfolded so that the fabric pieces are arranged at a regular interval.

FIG. 12 is a view illustrating a state in which the blind formed by fixedly coupling the plurality of pieces of the light-blocking fabric manufactured by the manufacturing method according to the embodiment.

FIGS. 13 and 14 are enlarged views illustrating a part of an attachment unit of the light-blocking fabric, according to the present invention.

FIGS. 15 and 16 examples of the attachment unit of the light-blocking fabric, according to the present invention.

FIGS. 17 and 18 are schematic top views illustrating the light-blocking fabric, according to the present invention.

FIGS. 19 and 20 are schematic partial views illustrating a blind made of the light-blocking fabric, according to the present invention.

<Description of the Reference Numerals in the Drawings>

| | |
|---|---|
| 100: light-blocking fabric | 110: light-shielding part |
| 111: Inner end | 112: outer end |
| 120: light-transmitting part | 121: overlapping part |
| 122: attachment part | 124: non-attachment part |
| 130: installation hole | |
| 140: fixing means | 141: coupling hole |
| 143: space | 145: fixing pin |
| 150: attachment unit | 160: interlining |
| 200: blind housing | 210: guide rail |
| 220: roller | 230: adjustment cord |

### DETAILED DESCRIPTION

Hereinbelow, exemplary embodiments of the present invention will be described in detail with reference to the accompanying drawings such that the invention can be easily embodied by one of ordinary skill in the art to which this invention belongs.

The present invention provides a light-blocking fabric which can be wound in a roll form uniformly without wrinkles on a light-shielding part and a light-transmitting part by balancing the thickness of the light-shielding part and the light-transmitting part, and can enable a blind to avoid the problem that the gaps in the blind may be eccentrically widened when the blind is unfolded as needed.

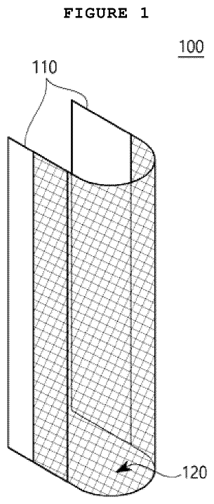

Referring to FIG. 1, the light-blocking fabric 100 according to the present invention is a light-blocking fabric which includes two light-shielding parts 110 made of a non-transparent fabric, and a light-transmitting part 120 made of a mesh fabric, located between the two light-shielding parts 110, and attached to a position that is at least half of any one surface of the light-shielding parts 110 so as to overlap therewith along the longitudinal direction. The light-blocking fabric can be used for blinds by continuously coupling adjacent light-blocking fabrics to each other.

In order to manufacture the above-described light-blocking fabric 100, the light-shielding parts 110 may use a fabric capable of blocking light into the room due to the low passage of light and wind, and a fabric such as non-transparent fabric.

The light-transmitting part 120 may use a fabric which is made of a mesh material capable of allowing the passage of air between the indoor and outdoor spaces while the light-shielding part 110 blocks light, and transmitting a certain amount of light. The material of the light-transmitting part 120 is not limited to a specific one. For example, a thin mesh cloth which is free to bend may be used, and various types of mesh fabrics may be selectively attached depending on the pattern or shape. Functionally, it is preferable to use a material having a transparency capable of appropriately reducing the shading and light level in the room.

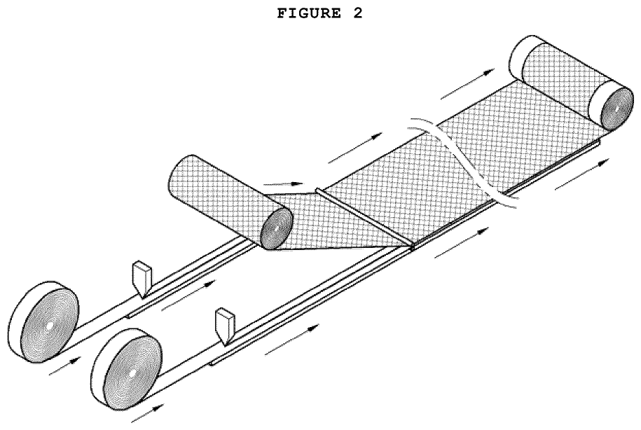

Referring to FIG. 2, in order to manufacture the light-blocking fabric 100, the prevent invention provides a manufacturing method for a light-blocking fabric, the method including: (a) a first injection step of unwinding two light-shielding part fabrics wound in a roll form, and injecting the same into a fabric processing apparatus; (b) a coating step of coating, with an adhesive, the position of at least half of any one surface of the two light-shielding part fabrics in the longitudinal direction while the two light-shielding part fabrics move along a guide part of the fabric processing apparatus; (c) a second injection step of unwinding a mesh fabric wound in a roll form, horizontally arranging and injecting the same into the fabric processing apparatus such that the same overlaps with the two light-shielding part fabrics on which the adhesive is coated in the coating step, at a position therebetween; (d) a manufacturing step of manufacturing a light-blocking fabric by attaching, to the mesh fabric injected in the second injection step, the two light-shielding part fabrics on which the adhesive is coated in the coating step along the guide part of the fabric processing apparatus; and (e) a winding step of winding, in a roll form, the light-blocking fabric manufactured in the manufacturing step.

At this time, the mesh fabric may be transferred to be positioned parallel to the longitudinal direction at a position of at least half of any one surface of the two fabrics so that the two fabrics and the mesh fabric overlap with each other to manufacture a light-blocking fabric 100.

In particular, the manufactured light-blocking fabric 100 may be configured to be able to be wound by the fabric processing apparatus in a roll form without being limited by length, and thus the light-blocking fabric 100 may also be manufactured in a roll form. However, the present invention is not limited to this.

In order to attach the above fabrics and mesh fabric in an overlapping form, a hot melt subjected to thermal treatment may be applied to the position of at least half of any one surface of the fabrics, or a fabric adhesive may be applied to the position, and then the fabrics and mesh fabric may be compressed to be attached together. The fabrics and mesh fabric may also be coupled to each other by stitching, sewing, or ultrasonic welding, and thus the fabrics and mesh fabric may be bonded together by various methods without being limited by the attachment method, thereby forming the light-shielding parts 110 and the light-transmitting part 120 of the light-blocking fabric 100 according to the present invention.

After the light-blocking fabric 100 in which the fabrics and mesh fabric are coupled to each other is manufactured as described above, when used for a blind, the light-blocking fabric may be cut to a predetermined length suitable for a space where the blind is to be installed, and then cut pieces may be coupled to each other to form a blind. When using the above-described light-blocking fabric 100, there is an advantage in that blinds can be installed in a desired length without being constrained by space.

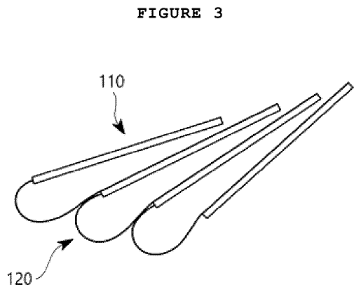

Referring to FIG. 3, the conventional art invented by the present inventor is a light-blocking fabric comprised of a single light-shielding part 110 and a light-transmitting part 120 connected to the end thereof. When a blind is manufactured by fixedly coupling a plurality of pieces of the light-blocking fabric, when the blind is adjusted to be closed for shading or wind protection, the gaps in the blind may be eccentrically widened due to the property of the light-transmitting part 120 that tends to be unfolded.

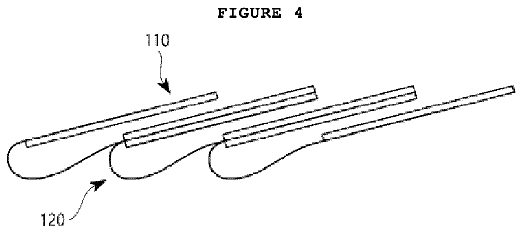

Accordingly, in the present invention, the two light-shielding parts 110 and the light-transmitting part 120 attached between the two light-shielding parts 110 are configured such that the light-transmitting part 120 is attached to the position of at least half of any one surface of the two light-shielding parts 110 so as to overlap therewith along the longitudinal direction. Thus, as illustrated in FIG. 4, the present invention has an advantage in that the property of the light-transmitting part 120 that tends to be unfolded can be sufficiently suppressed by the two light-shielding parts 110 when the blind is adjusted to be closed for shading or wind protection, whereby the the closed blind can avoid the problem that the gaps in the blind may be eccentrically widened, while maintaining shape.

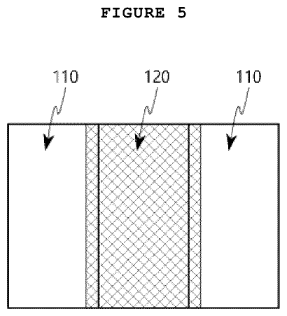

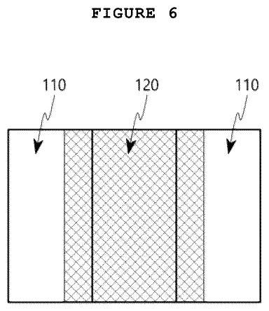

This may be described with reference to FIGS. 5 to 8. As illustrated in FIGS. 5 and 6, the light-transmitting part 120 may be attached along the longitudinal direction to a position of an end or less than half of any one surface of the two light-shielding parts 110, but in this case, the property of the light-transmitting part 120 that tends to be unfolded cannot be sufficiently suppressed, causing a problem in that the gaps in the blind may be eccentrically widened as in the conventional art invented by the present inventor.

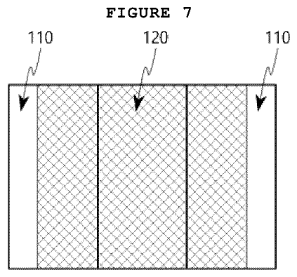

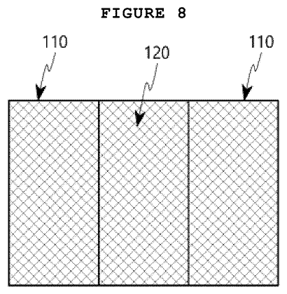

However, as illustrated in FIGS. 7 and 8, when the light-transmitting part 120 is attached to the position of at least half of any one surface of the two light-shielding parts 110 so as to overlap therewith along the longitudinal direction, the property of the light-transmitting part 120 that tends to be unfolded can be sufficiently suppressed by the two light-shielding parts 110 when the blind is adjusted to be closed for shading or wind protection, thereby enabling the closed blind to avoid the problem that the gaps in the blind may be eccentrically widened, while maintaining shape.

On the other hand, as described above, the light-blocking fabric 100 according to the present invention includes two light-shielding parts 110 made of a non-transparent fabric, and a light-transmitting part 120 located between two light-shielding parts 110 and attached to each of the two light-shielding parts 110 along the longitudinal direction. The light-transmitting part 120 is attached at a position located at least halfway along a width of any one surface of each of the two light-shielding parts 110 along the longitudinal direction. Specifically, the light-transmitting part 120 starts attaching to each of the two light-shielding parts 110 at the position that is at least half of a width of each of the two light-shielding parts (110) away from the inner end of each of the two light-shielding parts (110) in a width direction.

The longitudinal direction along which the light-transmitting part (120) is attached to each of the two light-shielding parts (110) may be perpendicular to the width direction of the each of the two light-shielding parts (110). In addition, this longitudinal direction may include various directions such as a zigzag direction in a left and right curved spiral shape that extend continuously from the top to the bottom of the light-transmitting part (120).

In addition, the inner surface of each of both edges of the light-transmitting part (120) in a width direction is attached to corresponding surface of each of the two light-shielding parts (110).

Specifically, the inner surfaces of both edges of the light-transmitting part (120) in a width direction, i.e., the opposing edges of the light-transmitting part (120), are attached to corresponding surfaces of the two light-shielding parts (110), i.e., the surfaces of the two light-shielding parts (110) that face the light-transmitting part (120).

Meanwhile, the light-transmitting part 120 may be attached to the light-shielding part 110 only in a portion of the area where the light-transmitting part 120 is overlapped with the light-shielding part 110, rather than the entire area of the overlapped area.

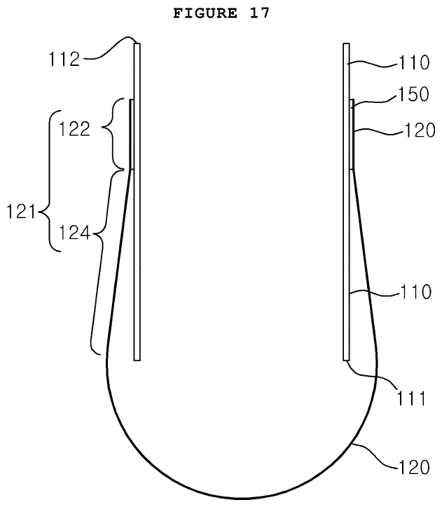

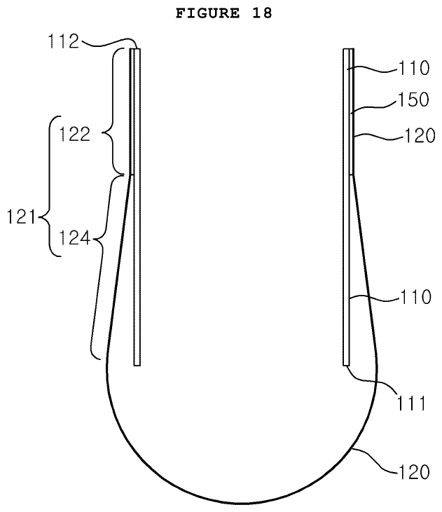

Specifically, by referring to FIGS. 17 and 18, the light-transmitting part 120 includes an overlapping part 121 that overlaps with each of the two light-shielding parts 110 when the light-transmitting part 120 is attached to each of the two light-shielding parts 110. The overlapping part 121 includes an attachment part 122 where the light-transmitting part 120 is attached to each of the two light-shielding parts 110 and a non-attachment part 124 where the light-transmitting part 120 is not attached to any of the two light-shielding parts 110.

As illustrated in FIG. 17, the attachment part 122 may be attached to a part of each of the two light-shielding parts 110 spanning from a first position that is more than halfway from the inner end 111 of each of the two light-shielding parts 110 in the width direction of the light-shielding part 110 to a second position between the first position and the outer end 112. In some embodiments, as illustrated in FIG. 18, the attachment part 122 may be attached to a part of each of the two light-shielding parts 110 spanning from a position that is more than halfway from the inner end 111 of each of the two light-shielding parts 110 in the width direction of the light-shielding part 110 to the outer end 112. The non-attachment part 124 overlaps with the light-shielding part 110 when viewed from the side of the light-transmitting part 120, but detaches from the light-shielding part 110 due to stiffness.

In some embodiments, there may be more than one position where the light-shielding part 110 and the light-transmitting part 120 are attached along the longitudinal direction. In this case, all positions where the light-shielding part 110 and the light-transmitting part 120 are attached along the longitudinal direction may be at least halfway along the width direction from the inner end of each of the two light-shielding parts 110.

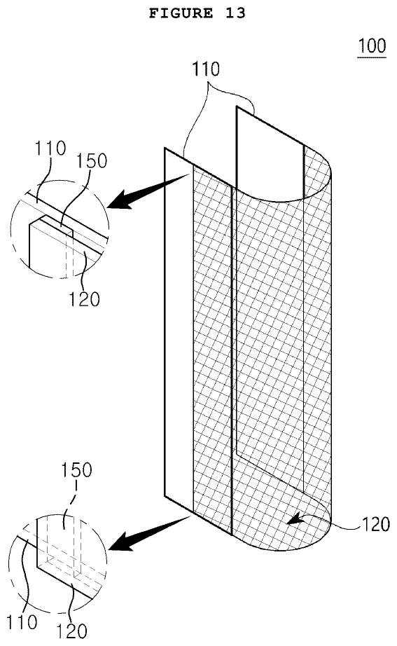

Specifically, the light-blocking fabric 100 may include an attachment unit 150 that is provided between the light-shielding part 110 and the light-transmitting part 120 and in an area where the light-shielding part 110 and the light-transmitting part 120 overlap, as illustrated in FIG. 13.

The attachment unit 150 is formed continuously between the light-transmitting part 120 and the light-shielding part 110 along the longitudinal direction of the light-transmitting part 120 and the light-shielding part 110. One attachment unit 150 may be formed at one position along the longitudinal direction of the light-transmitting part 120 and the light-shielding part 110. In addition, the attachment unit 150 may be any attachment unit for attaching the light-transmitting part 120 and the light-shielding part 110 to each other, such as an adhesive application unit, a hot melt adhesive unit, a sewing machine unit, and an ultrasonic fusion unit.

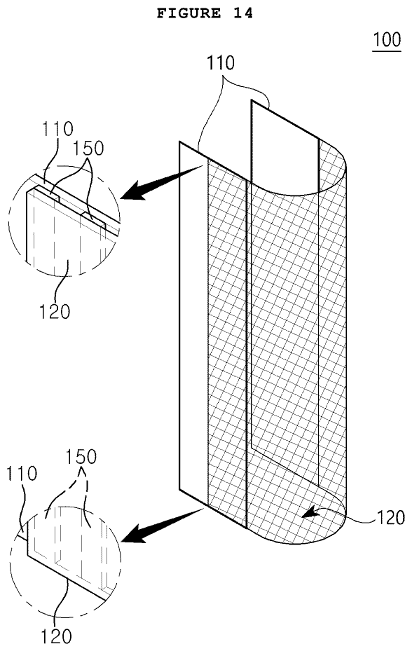

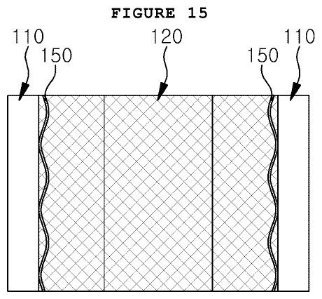

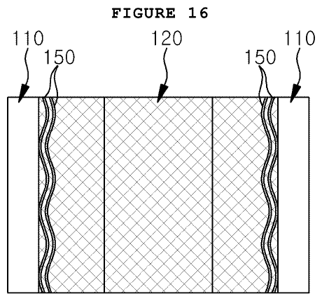

In addition, as illustrated in FIG. 14, a plurality of attachment units 150 may be provided separately between the light-transmitting part 120 and the light-shielding part 110. The plurality of attachment units 150 may be provided at regular intervals each other in an area where the light-transmitting part 120 and the light-shielding part 110 overlap each other such that the light-shielding part 110 and the light-transmitting part 120 are attached at a plurality of locations along the longitudinal direction. Each of the plurality of attachment units 150 may be located at least halfway along the width of a surface of each of the two light-shielding parts 110 from the inner end of each of the two light-shielding parts 110. Meanwhile, the attachment unit 150 may be formed in a direction perpendicular to the width direction of the light-shielding part 110, as shown in FIGS. 13 and 14 to attach the light-transmitting part 120 and the light-shielding part 110 to each other. Or, as shown in FIGS. 15 and 16, the attachment unit 150 may be formed in a spiral-shaped zigzag direction so that the light-transmitting part 120 and the light-shielding part 110 can be attached to each other.

In the present disclosure, as described above, the light-transmitting part 120 is attached along the longitudinal direction at more than half of one side of the light-shielding part 110. In particular, the light-transmitting part 120 starts attaching to each of the two light-shielding parts 110 at the position that is at least half of a width of each of the two light-shielding parts 110 away from an inner end 111 of each of the two light-shielding parts 110 in a width direction. Thus, in the present disclosure, by controlling the light-transmitting part according to the weight of the light-shielding part and giving the light-transmitting part the ability to go straight downward, it is possible to prevent the transmitting part from being waved. In addition, by preventing gaps or openings between the blinds that are rotated and shielded, the neat external shape of the blind can be maintained. Furthermore, when the blind is rotated, the rotational force is simultaneously transmitted to the lower part of the blind due to the weight of the light-shielding parts, which has the advantage of allowing the lower part of the blind to rotate in the same manner as the upper part of the blind.

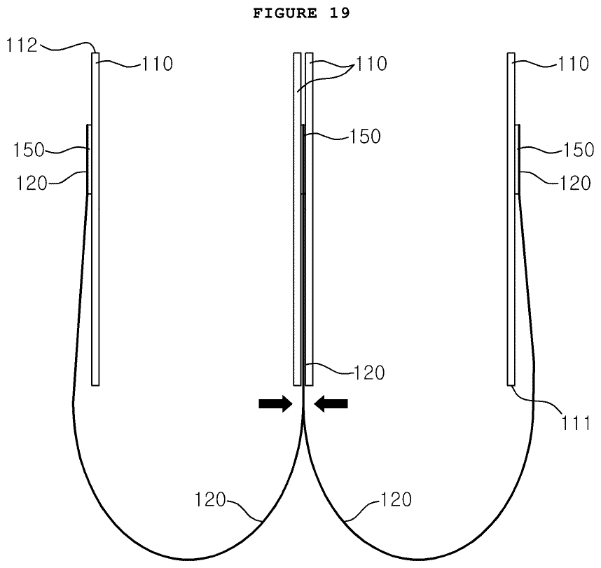

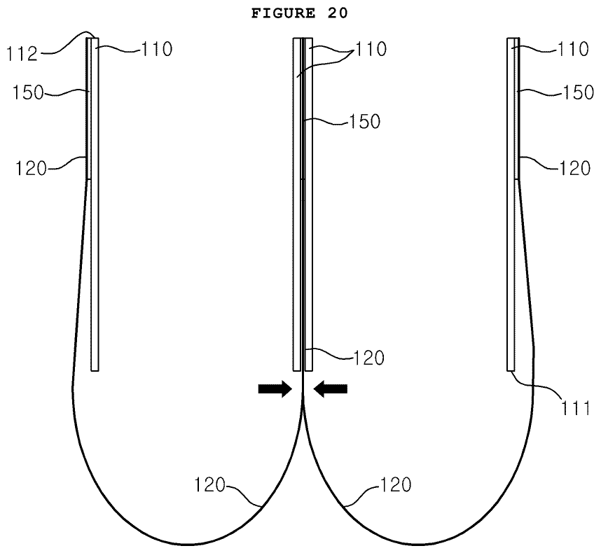

In particular, in the present disclosure, it is possible to prevent gaps between blinds even when the blinds are in an unfolded state. Referring to FIGS. 19 and 20, in the area where the light-transmitting part 120 and the light-shielding part 110 overlap each other, Since only a portion of the light-shielding part 110 is attached to the inner surface of the light-transmitting part 120 and the remaining portions of the light-transmitting part 120 are pushed against each other, there is an advantage in that the occurrence of gaps between blinds can be suppressed.

Specifically, in the present invention, a portion of the inner surface of the light-transmitting part 120 is attached only to a position that is more than halfway from the inner end 111 of the light-shielding part 110 in the width direction of the light-shielding part 110.

In particular, the remaining part of the light-transmitting part 120 that is not attached to the light-shielding part 110 tends to spread due to the stiffness of the light-transmitting part 120, and thus, spreads in the outer direction of the light-shielding fabric (as shown in the direction of the arrow in FIG. 18). In this regard, the light-transmitting parts 120 between each light-shielding fabric constituting the blind contact each other, which prevents gaps between each light-shielding fabric constituting the blind. Due to the above-described structure, the present invention may prevent gaps between blinds even when the blinds are in an unfolded state.

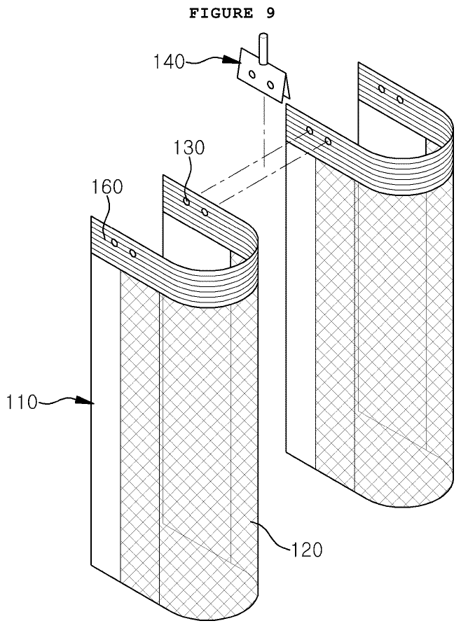

Meanwhile, the above-described pieces of the light-blocking fabric 100 may be coupled to each other by various methods. For example, referring to FIG. 9, a plurality of installation holes 130 are formed in each of the pieces of the light-blocking fabric 100 by using an auger or a punching machine to install the blind. The above-described installation holes 130 may be formed at corresponding positions so that two adjacent pieces of the light-blocking fabric 100 can be coupled to each other, and each of the pieces of the light-blocking fabric 100 and an adjacent piece of the light-blocking fabric 100 may be connected and coupled to each other using a fixing means 140 detachably attached to the installation holes 130.

Here, the installation hole 130 may have various shapes, and as shown in FIG. 9, two circular installation holes may be formed in the shielding portion, spaced a certain distance apart from each other. In addition, each installation hole 130 is provided with an eyelet around it to protect the light-shielding part 110 from fixing means that are to be inserted into the installation hole.

Additionally, a film or interlining 160 may be attached to a certain portion of the upper portion of the light-shielding part 110 or the light-transmitting part 120 to prevent damage to the fabric. In particular, the light-shielding part 110 may be damaged due to friction between the light-shielding part 110 and the fixing means. To prevent the damage, the film or interlining 160 may be heat-adhered around the edge of the installation hole 130 of the light-shielding part 110. Instead of the above-mentioned eyelet, the area around the installation hole 130 can be reinforced by attaching a film or interlining 160 around the installation hole 130. In addition, the film or interlining 160 may be installed on the upper part of the fabric such that the light-shielding part 110 may withstand friction.

Specifically, to provide more robust coupling of upper sides of the pieces of the light-blocking fabric 100 when the plurality of pieces of the light-blocking fabric 100 are coupled to each other, the installation holes 130 may be formed in such a manner that a film or interlining in the form of fabric is attached between each of the pieces of the light-blocking fabric 100 and then drilled.

Additionally, the fixing means 140 may use a means in a form of a detachable clip, and any other means can be used without limitation as long as being capable of fixing the pieces of the light-blocking fabric 100 to a rail of the blind, and allowing the light-shielding parts 110 to be tiltable.

Additionally, when more robust coupling of the above-described pieces of the light-blocking fabric 100 is desired, materials such as a removable Velcro tape, weight, or magnet may be attached to lower ends of the respective pieces of the light-blocking fabric 100 so that lower sides of the respective pieces of the light-blocking fabric 100 can be coupled to each other at positions corresponding to each other.

The light-blocking fabric 100 according to the present invention manufactured as described above is characterized in that a roll-type fabric comprised of the light-shielding parts 110 and the light-transmitting part 120 can be cut to fit the length according to the space in which the roll-type fabric is installed, and thus there is an advantage in that the blind is easy to adjust in height during installation and easy to handle during working, and that the blind can be installed without being constrained by the installation space.

Additionally, the light-transmitting part 120 can be embodied in a voluminous manner using a mesh fabric of various patterns thereby resulting in an elegant appearance. Furthermore, since the plurality of pieces of the light-blocking fabric 100 are connected to each other for installation when the blind is installed, the light-blocking fabric is easy to replace in case of contamination or damage. Moreover, the pieces of the light-blocking fabric 100 allows the passage of air between the indoor and outdoor spaces through the space between each of the pieces of the light-blocking fabric, thereby making it possible to provide a more comfortable environment compared to the environment in which a conventional blind is installed.

Hereinafter, the present invention will be described in more detail with reference to an exemplary embodiment. The following example is only for an illustrative purpose of describing the present invention in detail and should not be construed as limiting the scope of the present invention.

### Example

In this example, non-transparent fabrics and a mesh fabric wound in a roll form were put into a fabric processing apparatus, and the mesh fabric was attached between the non-transparent fabrics using a hot melt to manufacture a light-blocking fabric 100.

Then, the manufactured light-blocking fabric 100 was cut to a predetermined length to form a plurality of pieces, and two installation holes 130 were drilled on an upper side of each of the pieces of the light-blocking fabric 100 using a punching machine to manufacture a plurality of pieces of light-blocking fabric 100 each of which includes light-shielding parts 110, with the installation holes 130 formed.

Finally, each of the pieces of the light-blocking fabric 100 was positioned to face an adjacent piece of the light-blocking fabric 100 and then fixed using a fixing means 140 to couple lower ends of the adjacent pieces of the light-blocking fabric 100 to each other.

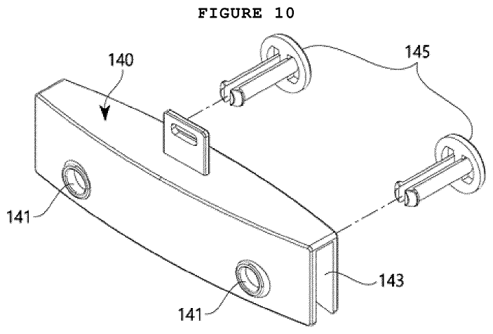

Referring to FIG. 10, the fixing means 140 in a form of a clip has a coupling hole 141 corresponding to each of a plurality of installation holes 130 formed in the pieces of the light-blocking fabric 100, so as to allow upper sides of each adjacent pieces of the light-blocking fabric 100 to be coupled to each other. The adjacent pieces of the light-blocking fabric 100 were positioned in a space 143 defined in the clip-shaped fixing means 140, and the upper sides of the adjacent pieces of the light-blocking fabric 100 were fixedly coupled to each other by a wedge-shaped fixing pin 145 passing through each of the installation holes 130 and each of the respective coupling holes 141.

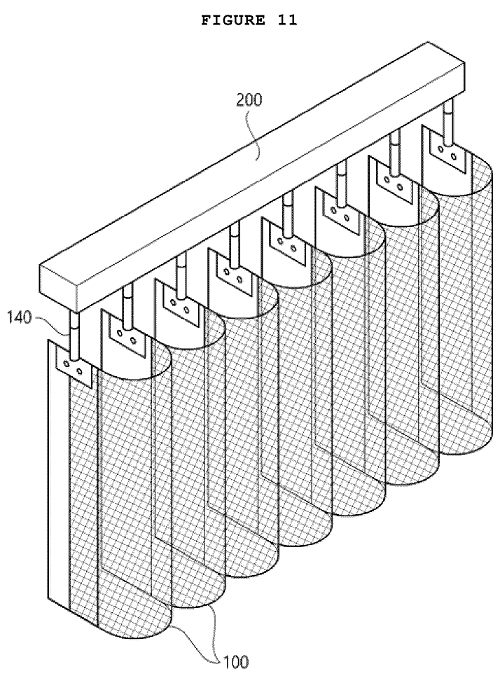

Referring to FIG. 11, the pieces of the light-blocking fabric 100 were fastened to a roller 220 of a guide rail 210 included in a blind housing 200 which will be described later so that the pieces of the light-blocking fabric 100 can be horizontally folded or unfolded over the guide rail 210, whereby a blind was completed.

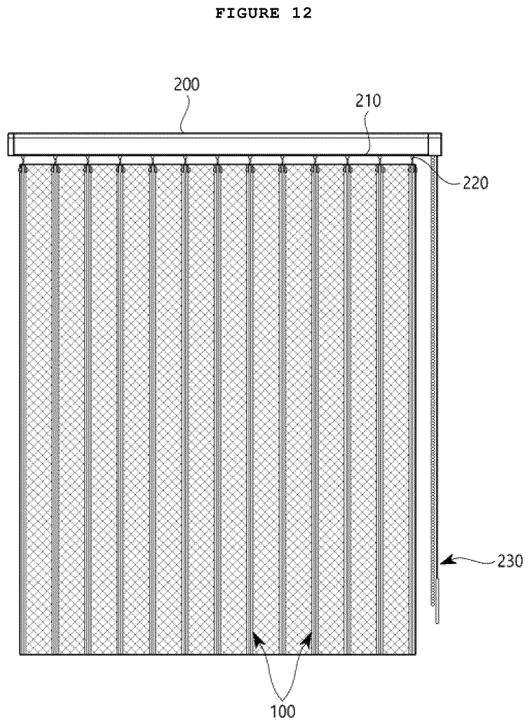

Referring to FIG. 12, the blind housing 200 used to manufacture the blind according to the example was configured using a conventionally known one, the clip-shaped fixing means was attached to each of plurality of rollers 220 that allows the pieces of the light-blocking fabric 100 to be horizontally folded or unfolded over the guide rail 210, and an adjustment cord 230 was installed to be attached to the fixing means 140 to allow the blind to be tilted by equal to or greater than 90° and to tilt the fixing means 140, wherein the adjustment cord 230 was configured to be located at a position passing through the upper side of the fixing means 140 so that the adjustment cord 230 is fastened, and to allow the tilting of the pieces of the light-blocking fabric 100.

In this state, when the adjustment cord 230 is pulled to shield the indoor and outdoor spaces, upper portions of the respective light-shielding parts 110 of the pieces of the light-blocking fabric 100 fixed by the fixing means 140 are tilted by 90°, allowing the respective light-shielding parts 110 to be maintained in a state substantially parallel to the window glass. Here, each surface of the light-shielding parts 110 is not deformed in the center portion thereof, and tilting force of the fixing means 140 allows the light-shielding parts 110 made of a non-light transmitting fabric to completely shield the indoor and outdoor spaces. Furthermore, when the respective light-shielding parts 110 are maintained in the direction perpendicular to the window glass, the indoor and outdoor spaces are opened. Thus, it was possible to manufacture a blind capable of lighting and ventilation through light-transmitting parts 120.

Although embodiments of the present invention were described in detail above, the scope of the present invention is not limited to a specific embodiment described above. It should be understood by those of ordinary skill in the art that various changes and modifications from the spirit of the present invention defined in the appended claims without departing from the gist of the present invention and such changes and modifications belong to the spirit and scope of the present invention.

### INDUSTRIAL APPLICABILITY

According to the present invention, a light-blocking fabric is manufactured by attaching a light-transmitting part along a longitudinal direction to a position of at least half of any one surface of two light-shielding parts. Thus, when wound in a roll form, the light-blocking fabric can be wound uniformly without wrinkles on the light-shielding parts and the light-transmitting part by balancing the thickness of the light-shielding parts and the light-transmitting part, thereby making it possible to prevent the problem of degrading the aesthetic appearance due to wrinkles. It is also possible to prevent the problem that when a blind manufactured using the light-blocking fabric is folded as need, the gaps in the blind may be eccentrically widened. Thus, the present invention can be more effectively used in the field of manufacturing a light-blocking fabric used for blinds.

1. A light-blocking fabric unit comprising:
two light-shielding parts (110) made of a non-transparent fabric; and
a light-transmitting part (120) located between the two light-shielding parts (110), and attached to each of the two light-shielding parts (110) along a longitudinal direction,
wherein the light-transmitting part (120) is attached at a position located at least halfway along a width of any one surface of each of the two light-shielding part along the longitudinal direction.

2. The light-blocking fabric unit of claim 1, wherein the light-transmitting part (120) starts attaching to each of the two light-shielding parts (110) at the position that is at least half of a width of each of the two light-shielding parts (110) away from an inner end of each of the two light-shielding parts (110) in a width direction.

3. The light-blocking fabric unit of claim 2, wherein the longitudinal direction along which the light-transmitting part (120) is attached to each of the two light-shielding parts (110) is perpendicular to the width direction of the each of the two light-shielding parts (110).

4. The light-blocking fabric unit of claim 1, wherein the light-transmitting part (120) is attached to light-shielding part (110) in an area, and
the area is a partial area of an overlapping part (121) where each of the two light-shielding parts (110) overlaps with the light-transmitting part (120).

5. The light-blocking fabric of claim 1, wherein the light-shielding parts (110) and the light-transmitting part (120) are attached together with a hot-melt or adhesive.

6. The light-blocking fabric of claim 1, wherein the light-shielding parts (110) and the light-transmitting part (120) are attached together by sewing or ultrasonic welding.

7. The light-blocking fabric of claim 1, wherein the light-transmitting part is attached to each of the two light-shielding parts (110) at one or more positions along the longitudinal direction.

8. The light-blocking fabric of claim 1, wherein an inner surface of each of both edges of the light-transmitting part (120) in a width direction is attached to corresponding surface of each of the two light-shielding parts (110).

9. The light-blocking fabric unit of claim 1, wherein the light-transmitting part (120) includes an overlapping part (121) that overlaps with each of the two light-shielding parts (110) when the light transmitting part (120) is attached to each of the two light-shielding parts (110), and
the overlapping part (121) includes an attachment part (122) where the light-transmitting part (120) is attached to each of the two light-shielding parts (110) and a non-attachment part (124) where the light-transmitting part (120) is not attached to any of the two light-shielding parts (110).

10. A blind comprising the light-blocking fabric of claim 1.
